(19) United States
(12) Patent Application Publication
(10) Pub. No.: US 2015/0166871 A1
(43) Pub. Date: Jun. 18, 2015

(54) Methods for Treating Subterreanean Formations

(71) Applicant: Schlumberger Technology Corporation, Sugar Land, TX (US)

(72) Inventors: Salim Taoutaou, Kuala Lumpur (MY); Kong Teng Ling, Johor (MY); Shameed Ashraf, Kuala Lumpur (MY)

(73) Assignee: Schlumberger Technology Corporation, Sugar Land, TX (US)

(21) Appl. No.: 14/108,323

(22) Filed: Dec. 16, 2013

(51) Int. Cl. C09K 8/44; E21B 33/13

(52) U.S. Cl. CPC C09K 8/44; E21B 33/13

(57) ABSTRACT

Cement compositions for well cementing operations comprise an isocyanate compound and solid particles. The solid particles are present in at least three distinct particle size groups. The compositions may further comprise a blocking agent and solvents such as polyols, hydrocarbon solvents, diesel or water. The compositions are particularly useful in the context of remedial cementing, which may be squeeze cementing or plug cementing.

### BACKGROUND

The statements in this section merely provide background information related to the present disclosure and may not constitute prior art.

The present disclosure broadly relates to compositions and methods for performing well cementing treatments.

During construction of a subterranean well, remedial operations may be required to maintain wellbore integrity during drilling, to cure drilling problems, or to repair defective primary cement jobs. Wellbore integrity may be compromised when drilling through mechanically weak formations, leading to hole enlargement. Cement slurries may be used to seal and consolidate the borehole walls. Remedial cementing is a common way to repair defective primary cement jobs, to either allow further drilling to proceed or to provide adequate zonal isolation for efficient well production.

During well production, remedial cementing operations may be performed to restore production, change production characteristics (e.g., to alter the gas/oil ratio or control water production), or repair corroded tubulars. During a stimulation treatment, the treatment fluids must enter the target zones and not leak behind the casing. If poor zonal isolation behind the production casing is suspected, a remedial cementing treatment may be necessary.

Well abandonment frequently involves placing cement plugs to ensure long-term zonal isolation between geological formations, replicating the previous natural barriers between zones. However, before a well can be abandoned, annular leaks must be sealed. Squeeze cementing techniques may be applied for this purpose.

Common cementitious-fluid systems employed during remedial cementing operations may include Portland cement slurries, calcium-aluminate cement slurries, and organic resins based on epoxies or furans.

### SUMMARY

The present disclosure reveals compositions and methods by which cements based on isocyanate polymers may be applied in the context of well cementing operations.

In an aspect, embodiments relate to methods for cementing a subterranean well having a borehole. A composition is prepared that comprises at least one isocyanate compound without a blocking agent, or at least one isocyanate compound with a blocking agent, and solid particles that are present in at least three distinct particle-size groups. The composition is placed in the well.

In a further aspect, embodiments relate to methods for restoring zonal isolation in a subterranean well having a borehole. The borehole has cracks, fissures, or vugs or combinations thereof through which fluids may escape. A composition is prepared that comprises at least one isocyanate compound without a blocking agent, or at least one isocyanate compound with a blocking agent, and solid particles that are present in at least three distinct particle-size groups. The composition is placed in the well adjacent to the cracks, fissures, or vugs or combinations thereof. The composition is then allowed to flow into the cracks, fissures or vugs or combinations thereof, thereby sealing the wellbore.

In yet a further aspect, embodiments relate to methods for treating a subterranean well having a borehole. A composition is prepared that comprises at least one isocyanate compound without a blocking agent, or at least one isocyanate compound with a blocking agent, and solid particles that are present in at least three distinct particle-size groups. The composition is placed in the well.

### DETAILED DESCRIPTION

Although the following discussion emphasizes remedial cementing operations, those skilled in the art will recognize that the disclosed compositions and methods may also be applicable to primary cementing and other operations during which the goal is to establish or restore zonal isolation. The disclosure will be described in terms of treatment of vertical wells, but is equally applicable to wells of any orientation. The disclosure will be described for hydrocarbon-production wells, but it is to be understood that the disclosed methods can be used for wells for the production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the Applicants appreciate and understand that any and all data points within the range are to be considered to have been specified, and that the Applicants have possession of the entire range and all points within the range.

As discussed earlier, cements based on epoxy resins or furans have been applied in well cementing operations. These cements are useful for primary cementing of wells in which the chemical environment may incompatible with Portland cement. Such wells include chemical waste disposal wells or geothermal wells that produce brines that are particularly aggressive. Resin based cement slurries are also useful in remedial cementing because, unlike Portland cement slurries, the continuous phase is cementitious. Therefore, the base fluid may seal cracks, fissures or vugs in a borehole, even when slurry solids are left behind. These polymer-based cements are commonly known in the art as “synthetic cements.” The Applicants have determined that fluids based on isocyanate polymers are useful as synthetic cements.

Polyurethanes are typically produced by the polyaddition reaction of a polyisocyanate with a polyalcohol (polyol). A polyisocyanate is a molecule containing two or more isocyanate functional groups, R—(N═C═O)ₙ with n>2, and a polyol is a molecule having two or more hydroxyl functional groups, R′—(OH)ₙ with n>2. The reaction product is a polymer containing the urethane linkage, —RNHCOOR′—, formed by the reaction between an isocyanate group and a hydroxyl group. On the other way, polyureas are produced by the polyaddition reaction of a polyisocyanate with a polyamine. As stated above, a polyisocyanate is a molecule containing two or more isocyanate functional groups, R—(N═C═O)ₙ with n>2, while a polyamine is a molecule having two or more amine functional groups, R′—(NH₂)ₙ with n>2. The reaction product is a polymer containing the urea linkage, —RNHCNHR′—, formed by the reaction between an isocyanate group with an amine group. Thus, in some embodiments, the polymers are formed from isocyanates that may react with an active hydrogen compound to form an elastomeric, gelatinous structure.

Isocyanates useful in embodiments disclosed herein may include isocyanates, polyisocyanates, and isocyanate prepolymers. Suitable polyisocyanates include any of the known aliphatic, alicyclic, cycloaliphatic, araliphatic, and aromatic di- and/or polyisocyanates. Inclusive of these isocyanates are variants such as uretdiones, biurets, allophanates, isocyanurates, carbodiimides, and carbamates, among others.

Aliphatic polyisocyanates may include hexamethylene diisocyanate, trimethylhexamethylene diisocyanate, dimeric acid diisocyanate, lysine diisocyanate and the like, and biuret-type adducts and isocyanurate ring adducts of these polyisocyanates. Alicyclic diisocyanates may include isophorone diisocyanate, 4,4′-methylenebis(cyclohexylisocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate, and the like, and biuret-type adducts and isocyanurate ring adducts of these polyisocyanate. Aromatic diisocyanate compounds may include xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluydine diisocyanate, 4,4′-diphenyl ether diisocyanate, m- or p phenylene diisocyanate, 4,4′-biphenylene diisocyanate, 3,3′-dimethyl-4,4′-biphenylene diisocyanate, bis(4-isocyanatophenyl)-sulfone, isopropylidenebis (4-phenylisocyanate), and the like, and biuret type adducts and isocyanurate ring adducts of these polyisocyanates. Polyisocyanates having three or more isocyanate groups per molecule may include, for example, triphenylmethane-4,4′,4″-triisocyanate, 1,3,5-triisocyanato-benzene, 2,4,6-triisocyanatotoluene, 4,4′-dimethyldiphenylmethane-2,2′,5,5′-tetraisocyanate, and the like, biuret type adducts and isocyanurate ring adducts of these polyisocyanates. Additionally, isocyanate compounds used herein may include urethanation adducts formed by reacting hydroxyl groups of polyols such as ethylene glycol, propylene glycol, 1,4-butylene glycol, dimethylolpropionic acid, polyalkylene glycol, trimethylolpropane, hexanetriol, and the like with the polyisocyanate compounds, and biuret type adducts and isocyanurate ring adducts of these polyisocyanates.

Other isocyanate compounds may include tetramethylene diisocyanate, toluene diisocyanate, hydrogenated diphenylmethane diisocyanate, hydrogenated xylylene diisocyanate, and trimers of these isocyanate compounds; terminal isocyanate group-containing compounds obtained by reacting the above isocyanate compound in an excess amount and a low molecular weight active hydrogen compounds {e.g., ethylene glycol, propylene glycol, trimethylolpropane, glycerol, sorbitol, ethylenediamine, monoethanolamine, diethanol amine, Methanol amine etc.) or high molecular weight active hydrogen compounds such as polyesterpolyols, polyetherpolyols, polyamides and the like may be used in embodiments disclosed herein.

Other useful polyisocyanates include, but are not limited to 1,2-ethylenediisocyanate, 2,2,4- and 2,4,4-trimethyl-1,6-hexamethylenediisocyanate, 1,12-dodecandiisocyanate, omega, omega-diisocyanatodipropylether, cyclobutan-1,3-diisocyanate, cyclohexan-1,3- and 1,4-diisocyanate, 2,4- and 2,6-diisocyanato-1-methylcylcohexane, 3-isocyanatomethyl-3,5,5-trimethylcyclohexylisocyanate (“isophoronediisocyanate”), 2,5- and 3,5-bis-(isocyanatomethyl)-8-methyl-1,4-methano, decahydronaphthathalin, 1,5-, 2,5-, 1,6- and 2,6-bis-(isocyanatomethyl)-4,7-methanohexahydroindan, 1,5-, 2,5-, 1,6- and 2,6-bis-(isocyanato)-4,7-methanohexahydroindan, dicyclohexyl-2,4′- and -4,4′-diisocyanate, omega, omega-diisocyanato-1,4-diethylbenzene, 1,3- and 1,4-phenylenediisocyanate, 4,4′-diisocyanatodiphenyl, 4,4′-diisocyanato-3,3′-dichlorodiphenyl, 4,4′-diisocyanato-3,3′methoxy-diphenyl, 4,4′-diisocyanato-3,3′-diphenyi-diphenyl, naphthalene-1,5-diisocyanate, N—N′-(4,4′-dimethyl-3,3′-diisocyanatodiphenye-uretdion, 2,4,4′-triisocyanatano-diphenylether, 4,4′,4″-IrUsOcyanatotriphenylmethant, and tris(4-isocyanatophenyl)-thiophosphate.

Other suitable polyisocyanates may include: 1,8-octamethylenediisocyanate; 1,11-undecane-methylenediisocyanate; 1,12-dodecamethylendiisocyanate; 1-isocyanato-3-isocyanatomethyl-3,5,5-trimethylcyclohexane; 1-isocyanato-1-methyl-4(3)-isocyanatomethylcyclohexane; 1-isocyanato-2-isocyanatomethylcyclopentane; (4,4′- and/or 2,4′-) diisocyanato-dicyclohexylm ethane; bis-(4-isocyanato-3-methylcyclohexyl)-methane; a,a,a′,a′-tetramethyl-1,3- and/or -1,4-xylylenediisocyanate; 1,3- and/or 1,4-hexahydroxylylene-diisocyanate; 2,4- and/or 2,6-hexahydrotoluene-diisocyanate; 2,4- and/or 2,6-toluene-diisocyanate; 4,4′- and/or 2,4′-diphenylmethane-diisocyanate; n-isopropenyl-dimethylbenzyl-isocyanate; any double bond containing isocyanate; and any of their derivatives having urethane-, isocyanurate-, allophanate-, biuret-, uretdione-, and/or iminooxadiazinedione groups.

Polyisocyanates may also include aliphatic compounds such as trimethylene, pentamethylene, 1,2-propylene, 1,2-butylene, 2,3-butylene, 1,3-butylene, ethylidene and butylidene diisocyanates, and substituted aromatic compounds such as dianisidine diisocyanate, 4,4′-diphenylether diisocyanate and chlorodiphenylene diisocyanate.

However, in order to prevent premature reaction with the active hydrogen compound, and thus gellation, the isocyanate is a blocked isocyanate. Blocked isocyanates are relatively recent in polyurethane technology. A blocked isocyanate is pre-reacted with a blocking group that is chemically related to a polyol or polyamine in that it has a nucleophilic atom (generally C, O, or N) and a transferrable proton to form a urethane, urea, or carboxamide linkage. Above a certain characteristic “deblocking” temperature, the blocked isocyanate will undergo reactions with polyols and/or polyamines to form polymer, but below the deblocking temperature the blocked isocyanate is chemically unreactive.

The coatings industry has made extensive use of blocked isocyanates to prepare coating formulations with extremely good shelf lives (unreactive blocked isocyantes intimately mixed with polyols that retain their chemical activity for months to years). The coating formulations only react to form polymeric polyurethane films above the deblocking temperature, and this process is irreversible because the blocking groups are selected for their volatility (i.e. they boil off and are no longer in the film to reverse the formation of polymer via urethane bond formation).

Blocked isocyanates are typically manufactured starting from acidic hydrogen-containing compounds such as phenol, ethyl acetoacetate and ε-caprolactam. Typical unblock temperatures range between 90 to 200° C., depending on the isocyanate structure and blocking agent. For example, aromatic isocyanates are typically unblocked at lower temperatures than those required to unblock aliphatic isocyanates. The dissociation temperature decreases according to the following order of blocking agents: alcohols>lactams>phenols>oximes>pyrazoles>active methylene groups compounds. Products such as methylethylcetoxime (MEKO), diethyl malonate (DEM) and 3,5-dimethylpyrazole (DMP) are typical blocking agents used, for example, by Baxenden Chemicals Limited (Accrington, England). DMP's unblock temperature is between 110-120° C., the melting point is 106° C. and boiling point is high, 218° C., without film surface volatilization problems. Trixene prepolymers may include 3,5-dimethylpyrazole (DMP) blocked isocyanates, which may be commercially available from Baxenden Chemicals Limited. The blocking groups H-BG (i.e. T_{deblock} is within reservoir temperature range) generally fall into four groups according to Table 1.

TABLE 1
Deblocking temperatures of selecte isocyanate blocking groups.

| Blocking Group | T_{deblock} (° C.) | Potential Scavenger |
|---|---|---|
| N-heterocycles (imidazoles, | 79 to 93 | Redox agents, copper salts |
| pyrazoles) | | |
| Oximes | 127 to 148 | Nitriles, quinones with iron |
| | | salts |
| β-diketones | 141 to 148 | Chromium (III) salts, iron |
| | | salts |

Suitable isocyanate blocking agents may include alcohols, ethers, phenols, malonate esters, methylenes, acetoacetate esters, lactams, oximes, and ureas, among others. Other blocking agents for isocyanate groups include compounds such as bisulphites, and phenols, alcohols, lactams, oximes and active methylene compounds, each containing a sulfone group. Also, mercaptans, triazoles, pyrrazoles, secondary amines, and also malonic esters and acetylacetic acid esters may be used as a blocking agent. The blocking agent may include glycolic acid esters, acid amides, aromatic amines, imides, active methylene compounds, ureas, diaryl compounds, imidazoles, carbamic acid esters, or sulfites.

For example, phenolic blocking agents may include phenol, cresol, xylenol, chlorophenol, ethylphenol and the like. Lactam blocking agent may include gamma-pyrrolidone, laurinlactam, epsilon-caprolactam, delta-valerolactam, gamma-butyrolactam, beta-propiolactam and the like. Methylene blocking agent may include acetoacetic ester, ethyl acetoacetate, acetyl acetone and the like. Oxime blocking agents may include formamidoxime, acetaldoxime, acetoxime, methylethylketoxime, dimethylketoxime, diacetylmonoxime, cyclohexanoxime and the like; mercaptan blocking agent such as butyl mercaptan, hexyl mercaptan, t-butyl mercaptan, thiophenol, methylthiophenol, ethylthiophenol and the like. Acid amide blocking agents may include acetic acid amide, benzamide and the like. Imide blocking agents may include succinimide, maleimide and the like. Amine blocking agents may include xylidine, aniline, butylamine, dibutylamine diisopropyl amine and benzyl-tert-butyl amine and the like.

Imidazole blocking agents may include imidazole, 2-ethylimidazole and the like. Imine blocking agents may include ethyleneimine, propyleneiniine and the like. Triazoles blocking agents may include compounds such as 1,2,4-triazole, 1,2,3-benzotriazole, 1,2,3-tolyl triazole and 4,5-diphenyl-1,2,3-triazole.

Alcohol blocking agents may include methanol, ethanol, propanol, butanol, amyl alcohol, ethylene glycol monomethyl ether, ethylene glycol monoethyl ether, ethylene glycol monobutyl ether, diethylene glycol monomethyl ether, propylene glycol monomethyl ether, benzyl alcohol, methyl glycolate, butyl glycolate, diacetone alcohol, methyl lactate, ethyl lactate and the like. Additionally, any suitable aliphatic, cycloaliphatic or aromatic alkyl monoalcohol may be used as a blocking agent in accordance with the present disclosure. For example, aliphatic alcohols, such as methyl, ethyl, chloroethyl, propyl, butyl, amyl, hexyl, heptyl, octyl, nonyl, 3,3,5-trimethylhexyl, decyl, and lauryl alcohols, and the like may be used. Suitable cycloaliphatic alcohols include, for example, cyclopentanol, cyclohexanol and the like, while aromatic-alkyl alcohols include phenylcarbinol, methylphenylcarbinol, and the like.

Examples of suitable dicarbonylmethane blocking agents include: malonic acid esters such as diethyl malonate, dimethyl malonate, di(iso)propyl malonate, di(iso)butyl malonate, di(iso)pentyl malonate, di(iso)hexyl malonate, di(iso)heptyl malonate, di(iso)octyl malonate, di(iso)nonyl malonate, di(iso)decyl malonate, alkoxyalkyl malonates, benzylmethyl malonate, di-tert-butyl malonate, ethyl-tert-butyl malonate, dibenzyl malonate; and acetylacetates such as methyl acetoacetate, ethyl acetoacetate, propyl acetoacetate, butyl acetoacetate and alkoxyalkylacetoacetates; cyanacetates such as cyanacetic acid ethylester; acetylacetone; 2,2-dimethyl-1,3-dioxane-4,6-dione; methyl trimethylsilyl malonate, ethyl trimethylsilyl malonate, and bis(trimethylsilyl) malonate.

Malonic or alkylmalonic acid esters derived from linear aliphatic, cycloaliphatic, and/or arylalkyl aliphatic alcohols may also be used. Such esters may be made by alcoholysis using any of the above-mentioned alcohols or any monoalcohol with any of the commercially available esters (e.g., diethylmalonate).

For example, diethyl malonate may be reacted with 2-ethylhexanol to obtain the bis-(2-ethylhexyl)-malonate. It is also possible to use mixtures of alcohols to obtain the corresponding mixed malonic or alkylmalonic acid esters. Suitable alkylmalonic acid esters include: butyl malonic acid diethylester, diethyl ethyl malonate, diethyl butyl malonate, diethyl isopropyl malonate, diethyl phenyl malonate, diethyl n-propyl malonate, diethyl isopropyl malonate, dimethyl allyl malonate, diethyl chloromalonate, and dimethyl chloro-malonate.

Active hydrogen compounds such as polyols and polyamines may be reacted with the blocked isocyanate, such as those disclosed herein, to form the polyurethane gel and polyurea gel, respectively.

For oilfield applications it may be logistically advantageous to prepare the isocyanate-based synthetic cement in aqueous media. The isocyanate functions as a reactive group. The reaction steps may be represented by the formulas represented in Eqs. 1-3.

R₁—NCO+H₂O→[R₁NHCOOH] Eq. 1

[R₁NHCOOH]→R₁NH₂+CO₂ Eq. 2

R₁NH₂+R₁NCO→R₁NHCONHR₁ Eq. 3

R1-NCO is the polyurethane prepolymer showing an isocyanate end group. The initial reaction of Eq. 1 forms the unstable carbamic acid [R₁NHCOOH]. Loss of carbon dioxide in Eq. 2 leads to the formation of the amine R₁NH₂. With excess isocyanate groups available for reaction, the amine R₁NH₂ will react to form the corresponding symmetrically substituted urea (Eq. 3). The leads to the formation of polyurethane-urea. The formation of urea in the polyurethane may provide the hardness of the final polymer.

Because the free isocyanate groups will react readily with active hydrogen compounds at room temperature, the blocking agent will render the free isocyanate groups inactive. This may also apply to the free reactive groups formed when polycyanates or polyisothiocyanates are used instead of polyisocyanates. The use of blocking agents provides more stable treatment fluids and allows longer

In an aspect, embodiments relate to methods for cementing a subterranean well having a borehole. A composition is prepared that comprises at least one isocyanate compound without a blocking agent, or at least one isocyanate compound with a blocking agent, and solid particles that are present in at least three distinct particle-size groups. The composition is placed in the well.

In a further aspect, embodiments relate to methods for restoring zonal isolation in a subterranean well having a borehole. The borehole has cracks, fissures, or vugs or combinations thereof through which fluids may escape. A composition is prepared that comprises at least one isocyanate compound without a blocking agent, or at least one isocyanate compound with a blocking agent, and solid particles that are present in at least three distinct particle-size groups. The composition is placed in the well adjacent to the cracks, fissures, or vugs or combinations thereof. The composition is then allowed to flow into the cracks, fissures or vugs or combinations thereof, thereby sealing the wellbore.

In yet a further aspect, embodiments relate to methods for treating a subterranean well having a borehole. A composition is prepared that comprises at least one isocyanate compound without a blocking agent, or at least one isocyanate compound with a blocking agent, and solid particles that are present in at least three distinct particle-size groups. The composition is placed in the well.

For all aspects, the isocyanate may comprise methylene diphenyl diisocyanate, hexamethylene diisocyanate trimer, 1,3-phenylene diisocyanate, 1,4-phenylene di-isocyanate, 4,4′-diphenyldiisocyanate, 4,4′-diphenylmethane diisocyanate, 2,4-tolylene diisocyanate, 2,6 tolylene diisocyanate, 4,4′-toluidine diisocyanate, dianisidine diisocyanate, 4,4′-diphenylether diisocyanate, 4,4′,4′-triphenylmethane triisocyanate, 1,3,5-triisocyanatobenzene, 2,4,6-triisocyanatotoluene. trimethylene diisocyanate, tetramethylene diisocyanate, pentamethylene diisocyanate, 1,2-propylene diisocyanate, 2,3-butylene diisocyanate, 1,3-butylene diisocyanate, 2,4,4-trimethylhexamethylene diisocyanate, 2,2,4-trimethylhexamethylene diisocyanate, methyl 2,6-diisocyanatocaproate, ω,ω′-diisocyanato-1,3-dimethylbenzene, ω,ω′-diisocyanato-1,4-dimethylbenzene, ω,ω′-diisocyanato-1,4-diethylbenzene, 1,3-tetramethylxylene diisocyanate, 1,4-tetramethylxylene diisocyanate, 1,3-cyclopentane diisocyanate, 1,4-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis-(cyclohexylisocyanate), methyl-2,4-cyclohexane diisocyanate, methyl-2,6-cyclohexane diisocyanate, 1,4-bis(isocyanatomethyl) cyclohexane or 1,3-bis(isocyanatomethyl)cyclohexane, or combinations thereof.

For all aspects, the composition may further comprise a blocking agent that is able to unblocked at or above a deblocking temperature. The blocking agent may comprise dimethyl ketoxime, methyl ethyl ketoxime, ε-caprolactam (ε-CAP), 1,2,4-triazole (TRIA), diisopropylamine (DIPA), 3,5-dimethylpyrazole (DMP) or diethyl malonate (DEM) or combinations thereof. Unblocked isocyanates may be used in lower temperature applications below about 90° C. and the blocked isocyanates may be used at higher temperatures.

For all aspects, the composition may further comprise a solvent comprising polyols, hydrocarbon solvents, diesel or water or combinations thereof. The solvent may comprise ethyl acetate, butyl acetate, amyl acetate, dipropyl acetate, CELLOSOLVE™ acetate (available from The Dow Chemical Company), carbitol acetate, dimethylesters of dibasic acids, methyl ethyl ketone, methyl isobutyl ketone, cyclohexanone, dipropyl ether, dioxane, tetrahydrofuran, toluene, benzene, xylene, mineral oil, mineral spirits, diesel, bio-diesel, crude oil, methylene chloride, trichloroethylene, perchloroethylene, chlorobenzene, dichlorobenzene or nitroraliphatic solvents orcombinations of these. The polyol may be an oleochemical polyol derived from palm oil, olive oil, castor oil, soybean oil, almond oil, safflower seed oil, niger seed oil, tobacco seed oil, peanut oil, cottonseed oil, sunflower seed oil, rapeseed oil, linseed oil, tung oil, babassu kernel oil, sesame oil, coconut oil, or corn oil or combinations thereof. Such oleochemical polyols may have two or more —OH groups located adjacent to carbon atoms.

For all aspects, the deblocking temperature T_{deblock} may be between 80° C. and 160° C.

For all aspects, the particles may comprise silica, barite, hematite, ilmenite, manganese tetraoxide, cenospheres, uintaite, glass microspheres, elastomer particles or plastic particles or combinations thereof. The plastic particles may comprise polycarbonate or polyethylene or combinations thereof. The elastomer particles may comprise rubbers, chlorofluorocarbons, tetrafluoroethylene-propylene copolymers, ethylene-propylene copolymers, isobutene-isoprene rubbers, nitrile rubbers, hydrogenated nitrile butadiene rubbers, or tetrafluoroethylene-perfluorovinyl methyl ether copolymers or combinations thereof.

For all aspects, the particles are present in at least three distinct particle-size groups. A trimodal particle-size distribution of the particulate materials allows the composition to have a higher solid-volume fraction, yet retain optimal rheological properties and stability. In addition, after curing, the synthetic cement may be less permeable and develop higher compressive strength. The solid volume fraction is the ratio between the volume of solids in a slurry and the total slurry volume. The solid volume fraction can be maximized by using coarse, medium and fine particles in specific volumetric ratios. The fine particles fit in the void spaces between the medium-size particles, and the medium-size particles fit in the void spaces between the coarse particles. For two consecutive granulometric classes, the order of magnitude between the mean particle diameter (d₅₀) of each class should ideally be between 7 and 10. For the disclosed compositions, the d₅₀ of the first material may be between about 300 and 500 μm, the second material may be between about 10 and 30 μm and the third material may be between about 1 and 3 μm.

For all aspects, the solid particles may be present in the compositions at concentrations between 62% and 77% by weight. The liquid phase may be present at concentrations between 38% and 23% by weight. The isocyanate compounds may be present at concentrations between 3.0% and 6.0% by weight. The solvent may be present at concentrations between 19% and 28% by volume.

The following examples serve to further illustrate the disclosure.

### EXAMPLES

### Example 1

The following tests were performed according to recommended practices published by the American Petroleum Institute (API Publication RP 10B) and the International Organization for Standards (ISO 10426-2).

Seven synthetic cement formulations were prepared whose compositions are given in Table 2. The polyol was PK SU32, or Polygreen 31 polyol, available from Maskimi or Polygreen. The unblocked isocyanate in Tests 1-4 was methylene diphenyl diisocyanate (Lupranat M205), available from BASF. The blocked isocyanate was a commerical product containing hexamethylene diisocyanate trimer preblended with DMP as the blocking agent (BI 7986, available from Baxenden Chemicals Ltd.). The coarse silica was LG50, available from Plomp Mineral Services. The medium silica was PSF 325, available from Plomp Mineral Services. The fine silica was Min-U-Sil-10, available from US Silica. The sand was S020, available from Unimim Corp.

TABLE 2
Isocyanate synthetic cement compositions.

| Chemical | Test 1 | Test 2 | Test 3 | Test 4 | Test 5 | Test 6 | Test 7 |
|---|---|---|---|---|---|---|---|
| Polyol, g | 15 | 15 | 7.5 | 15 | — | — | — |
| Isocyanate, g | 5.86 | 6.45 | 3.2 | 5.86 | — | 4 | — |
| Xylene, ml | 20 | 20 | 30 | 20 | — | — | — |
| Blocked isocyanate, g | | | | | 20 | 120 | 20 |
| coarse silica, g | 42 | 42 | 42 | 42 | 42 | 128 | — |
| medium silica, g | 7.5 | 7.5 | 7.5 | 7.5 | 7.5 | 23 | — |
| fine silica, g | 16 | 16 | 16 | 16 | 16 | 49 | — |
| Sand, g | — | — | — | — | — | — | 60 |

The compositions were prepared and placed into 50-mL plastic syringe molds and cured for various time periods and temperatures. After the curing periods, the gas permeability and compressive strength were measured. The results are shown in Table 3.

TABLE 3
Gas Permeability and Compressive Strength Measurements.

| | Curing | | Gas | |
|---|---|---|---|---|
| | Temperature | Curing Time | Permeability | Compressive |
| Test | (° C.) | (hr) | (mD) | Strength (MPa) |
| 1 | 100 | 4 | 0.03* | 6.9 |
| 2 | 100 | 4 | 78 | 5.5 |
| 3 | 100 | 4 | — | 2.1 |
| 4 | 27 | 18 | 0.02* | 7.6 |
| 5 | 95 | 24 | — | 2.1 |
| 6 | 95 | 24 | — | 2.1 |
| 7 | 95 | 24 | — | 3.5 |

*Applicant believes the permeability is essentially zero, as the reported value is lower than the accuracy of the permeameter.

Tests 1 to Test 4 were utilized a non-blocked isocyanate in the formulation. Test 2 indicated that higher concentration of isocyanate will lead to reduction in compressive strength but promoted higher permeability of the final product. On the other hand, Test 3 showed that diluting the active ingredient with a solvent can lead to reduction of compressive strength. Test 4 indicated that increasing the curing time from 4 hours to 18 hours, but reducing the curing temperature from 100° C. to 27° C. may improve the compressive strength of the cured product. Tests 5 to Test 7 incorporated blocked isocyanate into the test formulations. In general, testing indicated that water-based blocked isocyanate formulations may have lower compressive strengths compare to un-blocked isocyanate systems. However, those skilled in the art will recognize that the compressive strengths reported above are sufficiently high to perform satisfactorily in the context of well cementing.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A method for cementing a subterranean well having a borehole, comprising:
(i) preparing a composition comprising at least one isocyanate compound without a blocking agent or at least one isocyanate compound with a blocking agent and solid particles, wherein the particles are present in at least three distinct particle-size groups; and
(ii) placing the composition in the well.

2. The method of claim 1, wherein the isocyanate comprises methylene diphenyl diisocyanate, hexamethylene diisocyanate trimer, 1,3-phenylene diisocyanate, 1,4-phenylene di-isocyanate, 4,4′-diphenyldiisocyanate, 4,4′-diphenylmethane diisocyanate, 2,4-tolylene diisocyanate, 2,6 tolylene diisocyanate, 4,4′-toluidine diisocyanate, dianisidine diisocyanate, 4,4′-diphenylether diisocyanate, 4,4′,4′-triphenylmethane triisocyanate, 1,3,5-triisocyanatobenzene, 2,4,6-triisocyanatotoluene. trimethylene diisocyanate, tetramethylene diisocyanate, pentamethylene diisocyanate, 1,2-propylene diisocyanate, 2,3-butylene diisocyanate, 1,3-butylene diisocyanate, 2,4,4-trimethylhexamethylene diisocyanate, 2,2,4-trimethylhexamethylene diisocyanate, methyl 2,6-diisocyanatocaproate, ω,ω′-diisocyanato-1,3-dimethylbenzene, ω,ω′-diisocyanato-1,4-dimethylbenzene, ω,ω′-diisocyanato-1,4-diethylbenzene, 1,3-tetramethylxylene diisocyanate, 1,4-tetramethylxylene diisocyanate, 1,3-cyclopentane diisocyanate, 1,4-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis-(cyclohexylisocyanate), methyl-2,4-cyclohexane diisocyanate, methyl-2,6-cyclohexane diisocyanate, 1,4-bis(isocyanatomethyl) cyclohexane or 1,3-bis(isocyanatomethyl)cyclohexane, or combinations thereof.

3. The method of claim 1, wherein the blocking agent is able to be unblocked at or above a deblocking temperature, and comprises dimethyl ketoxime, methyl ethyl ketoxime, ε-caprolactam, 1,2,4-triazole diisopropylamine, 3,5-dimethylpyrazole or diethyl malonate or combinations thereof, and the composition is exposed to a temperature in the borehole that exceeds the deblocking temperature.

4. The method of claim 1, wherein the composition further comprises a solvent comprising polyols, hydrocarbon solvents, diesel or water or combinations thereof.

5. The method of claim 1, wherein the deblocking temperature in the well is between 80° C. and 160° C.

6. The method of claim 1, wherein the particles comprise silica, barite, hematite, ilmenite, manganese tetraoxide, cenospheres, glass microspheres or plastics or combinations thereof.

7. The method of claim 1, wherein the cementing is squeeze cementing or plug cementing.

8. A method for restoring zonal isolation in a subterranean well having a borehole with cracks, fissures or vugs, or combinations thereof through which fluids may escape, comprising:
(i) preparing a composition comprising at least one isocyanate compound without a blocking agent or at least one isocyanate compound with a blocking agent and solid particles, wherein the particles are present in at least three distinct particle-size groups;
(ii) placing the composition in the well adjacent to the cracks, fissures or vugs or combinations thereof; and
(iii) allowing the composition to flow into the cracks, fissures or vugs or combinations thereof, thereby sealing the borehole.

9. The method of claim 8, wherein the isocyanate comprises methylene diphenyl diisocyanate, hexamethylene diisocyanate trimer, 1,3-phenylene diisocyanate, 1,4-phenylene di-isocyanate, 4,4′-diphenyldiisocyanate, 4,4′-diphenylmethane diisocyanate, 2,4-tolylene diisocyanate, 2,6 tolylene diisocyanate, 4,4′-toluidine diisocyanate, dianisidine diisocyanate, 4,4′-diphenylether diisocyanate, 4,4′,4′-triphenylmethane triisocyanate, 1,3,5-triisocyanatobenzene, 2,4,6-triisocyanatotoluene. trimethylene diisocyanate, tetramethylene diisocyanate, pentamethylene diisocyanate, 1,2-propylene diisocyanate, 2,3-butylene diisocyanate, 1,3-butylene diisocyanate, 2,4,4-trimethylhexamethylene diisocyanate, 2,2,4-trimethylhexamethylene diisocyanate, methyl 2,6-diisocyanatocaproate, ω,ω′-diisocyanato-1,3-dimethylbenzene, ω,ω′-diisocyanato-1,4-dimethylbenzene, ω,ω′-diisocyanato-1,4-diethylbenzene, 1,3-tetramethylxylene diisocyanate, 1,4-tetramethylxylene diisocyanate, 1,3-cyclopentane diisocyanate, 1,4-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis-(cyclohexylisocyanate), methyl-2,4-cyclohexane diisocyanate, methyl-2,6-cyclohexane diisocyanate, 1,4-bis(isocyanatomethyl) cyclohexane or 1,3-bis(isocyanatomethyl)cyclohexane, or combinations thereof.

10. The method of claim 8, wherein the blocking agent is able to be unblocked at or above a deblocking temperature, and comprises dimethyl ketoxime, methyl ethyl ketoxime, ε-caprolactam, 1,2,4-triazole diisopropylamine, 3,5-dimethylpyrazole or diethyl malonate or combinations thereof, and the composition is exposed to a temperature in the borehole that exceeds the deblocking temperature.

11. The method of claim 8, wherein the composition further comprises a solvent comprising polyols, hydrocarbon solvents, diesel or water or combinations thereof.

12. The method of claim 8, wherein the deblocking temperature in the well is between 80° C. and 160° C.

13. The method of claim 8, wherein the particles comprise silica, barite, hematite, ilmenite, manganese tetraoxide, cenospheres, glass microspheres or plastics or combinations thereof.

14. A method for treating a subterranean well having a borehole, comprising:
(i) preparing a composition comprising at least one isocyanate compound without a blocking agent or at least one isocyanate compound with a blocking agent and solid particles, wherein the particles are present in at least three distinct particle-size groups; and
(ii) placing the composition in the well.

15. The method of claim 14, wherein the isocyanate comprises methylene diphenyl diisocyanate, hexamethylene diisocyanate trimer, 1,3-phenylene diisocyanate, 1,4-phenylene di-isocyanate, 4,4′-diphenyldiisocyanate, 4,4′-diphenylmethane diisocyanate, 2,4-tolylene diisocyanate, 2,6 tolylene diisocyanate, 4,4′-toluidine diisocyanate, dianisidine diisocyanate, 4,4′-diphenylether diisocyanate, 4,4′,4′-triphenylmethane triisocyanate, 1,3,5-triisocyanatobenzene, 2,4,6-triisocyanatotoluene. trimethylene diisocyanate, tetramethylene diisocyanate, pentamethylene diisocyanate, 1,2-propylene diisocyanate, 2,3-butylene diisocyanate, 1,3-butylene diisocyanate, 2,4,4-trimethylhexamethylene diisocyanate, 2,2,4-trimethylhexamethylene diisocyanate, methyl 2,6-diisocyanatocaproate, ω,ω′-diisocyanato-1,3-dimethylbenzene, ω,ω′-diisocyanato-1,4-dimethylbenzene, ω,ω′-diisocyanato-1,4-diethylbenzene, 1,3-tetramethylxylene diisocyanate, 1,4-tetramethylxylene diisocyanate, 1,3-cyclopentane diisocyanate, 1,4-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis-(cyclohexylisocyanate), methyl-2,4-cyclohexane diisocyanate, methyl-2,6-cyclohexane diisocyanate, 1,4-bis(isocyanatomethyl) cyclohexane or 1,3-bis(isocyanatomethyl)cyclohexane, or combinations thereof.

16. The method of claim 14, wherein the blocking agent is able to be unblocked at or above a deblocking temperature, and comprises dimethyl ketoxime, methyl ethyl ketoxime, ε-caprolactam, 1,2,4-triazole diisopropylamine, 3,5-dimethylpyrazole or diethyl malonate or combinations thereof, and the composition is exposed to a temperature in the borehole that exceeds the deblocking temperature.

17. The method of claim 14, wherein the composition further comprises a solvent comprising polyols, hydrocarbon solvents, diesel or water or combinations thereof.

18. The method of claim 14, wherein the deblocking temperature in the well is between 80° C. and 160° C.

19. The method of claim 14, wherein the particles comprise silica, barite, hematite, ilmenite, manganese tetraoxide, cenospheres, glass microspheres or plastics or combinations thereof.

20. The method of claim 14, wherein the treating comprises squeeze cementing or plug cementing.
